(19) United States
(12) Patent Application Publication
(10) Pub. No.: US 2003/0212750 A1
(43) Pub. Date: Nov. 13, 2003

(54) Remotely controlling a computer over a network

(76) Inventor: Alan B. Butt, Orem, UT (US)

Correspondence Address: KENYON & KENYON, 1500 K STREET, N.W., SUITE 700, WASHINGTON, DC, 20005, US

(21) Appl. No.: 10/140,866

(22) Filed: May 9, 2002

(51) Int. Cl. G06F 15/16

(52) U.S. Cl. 709/208

(57) ABSTRACT

A method of remotely controlling a computer includes receiving connection requests from a viewer computer and an agent computer, and adding the identities of the viewer computer and agent computer connections to a connection table. The viewer computer requests the agent computer connection in order to control the agent computer. The method further includes establishing a communication channel between the viewer computer and the agent computer.

### FIELD OF THE INVENTION

One embodiment of the present invention is directed to computer networks. More particularly, one embodiment of the present invention is directed to remotely controlling a computer over a network.

### BACKGROUND INFORMATION

Products that allow the remote control and remote management of computers are widely available. Examples of such products include LANDesk from Intel Corp., and PcAnywhere from Symantec Corp. The remote control features enable a user at a “controller” computer to control a “controlled” computer that is geographically separated from the controller computer over a network. By transferring bitmaps, keystrokes and mouse events over the network, the user can operate the controlled computer remotely as if the user is physically located at the controlled computer.

The existing remote control products work primarily in an Intranet environment. However, more and more companies and individuals are using the Internet for the backbone of their communications. Access to the Internet, especially in corporate settings, usually requires going through a firewall or proxy server. Even many Intranets are increasingly being partitioned with internal firewalls and proxies.

Unfortunately, most of the existing remote control products are blocked by firewalls and proxies, preventing remote control and management operations. While it is technically possible to open ports in a firewall to allow management and control, most network administrators are reluctant to do so for security reasons.

Based on the foregoing, there is a need for a system and method to remotely control a computer over a network even in the presence of firewalls or proxy servers.

### BRIEF DESCRIPTION OF THE DRAWINGS

FIG. 1 is an overview diagram of a communication system in accordance with one embodiment of the present invention.

FIG. 2 is a flow diagram of the functions performed by the communication system in accordance with one embodiment of the present invention.

### DETAILED DESCRIPTION

One embodiment of the present invention is a system that uses a data pump server to exchange data between a viewer computer and an agent computer over the Internet. The viewer computer and agent computer initially establish communication sessions to the data pump server, and data can pass through any firewalls or proxy servers located at the viewer or agent computers.

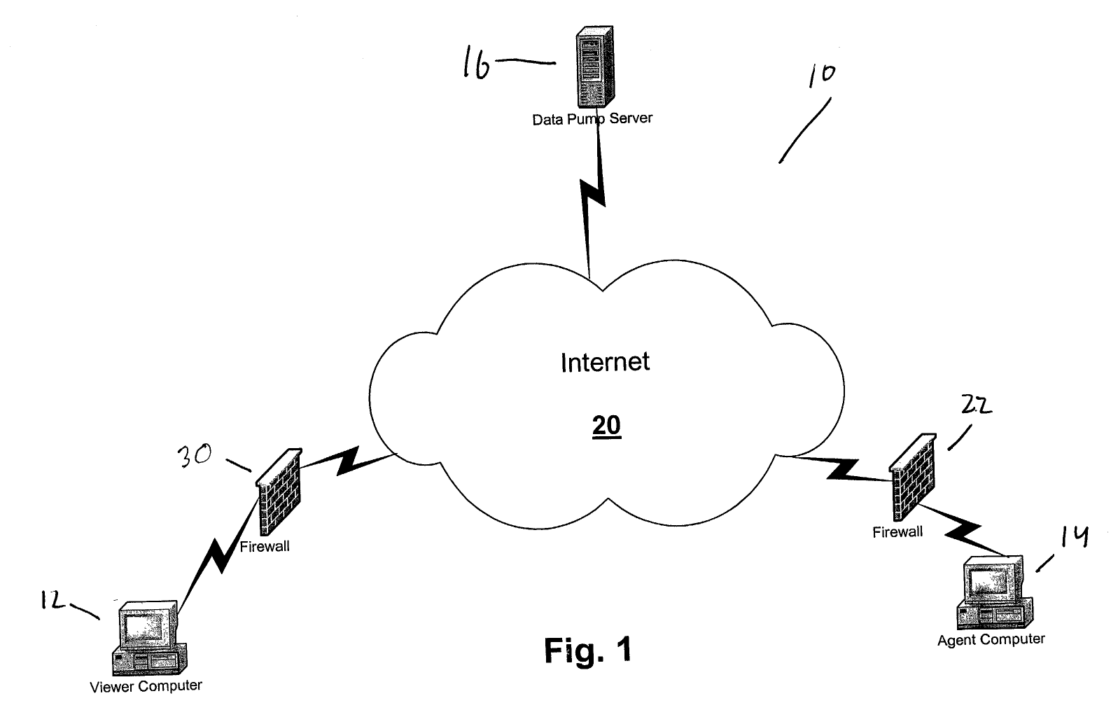

FIG. 1 is an overview diagram of a communication system 10 in accordance with one embodiment of the present invention. System 10 includes a viewer computer 12 and an agent computer 14 coupled to the Internet 20. Viewer computer 12 functions as the “controller” computer. Agent computer 14 functions as the “controlled” computer.

Computers 12 and 14 may be any type of computer that is capable of accessing Internet 20 and executing software steps. In one embodiment, computers 12 and 14 include a processor and memory, and execute an operating system and an Internet Web browser, such as the Internet Explorer browser from Microsoft Corp. In one embodiment, the processor is the Pentium 4 processor from Intel Corp. and the operating system is Windows XP from Microsoft Corp.

Viewer computer 12 stores on its memory, and executes in its processor, software instructions that provides the function of viewing and controlling a remote computer. In one embodiment, the software is LANDesk from Intel Corp. Other examples of viewer software includes PcAnywhere from Symantec Corp. and NetMeeting from Microsoft Corp. Viewer computer 12 also stores and executes software instructions that provide additionally functionality described below.

Agent computer 14 stores on its memory, and executes in its processor, software instructions that provides the function of being controlled by a remote computer. In one embodiment, the software is LANDesk from Intel Corp. Other examples of agent software that allow agent computer 14 to be remotely controlled includes PcAnywhere from Symantec Corp. and NetMeeting from Microsoft Corp. Agent computer 14 also stores and executes software instructions that provide additional functionality described below.

Viewer computer 12 and agent computer 14 access Internet 20 through firewalls 30 and 22, respectively. In other embodiments, viewer computer 12 and agent computer 14 each may access Internet 20 through a proxy server, both a proxy server and firewall, multiple levels of firewalls, or direct without passing through a firewall or proxy server.

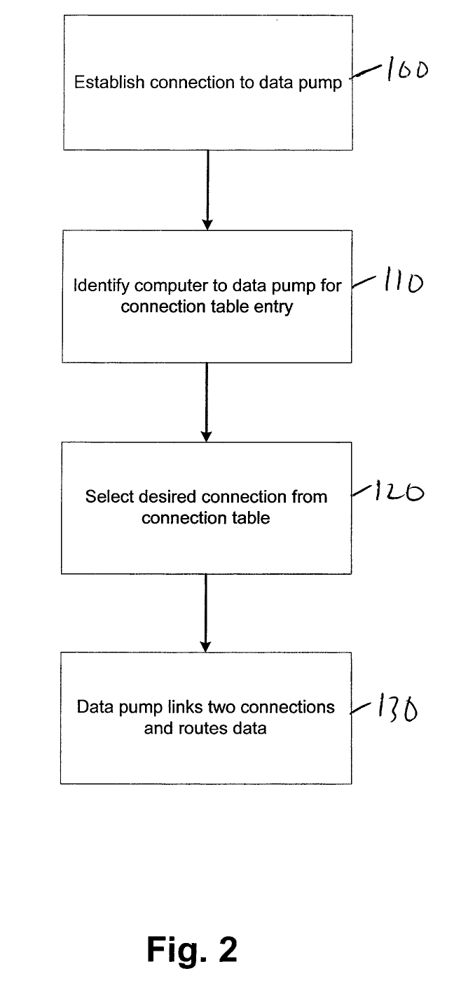

FIG. 2 is a flow diagram of the functions performed by communication system 10 in accordance with one embodiment of the present invention. In one embodiment, the functionality is implemented by software stored in memory and executed by processors. In other embodiments, the functions can be performed by hardware, or any combination of hardware and software. The functionality may be performed by viewer computer 12, agent computer 14, or data pump server 16 of FIG. 1.

At box 100, both viewer computer 12 and agent computer 14 establish a connection with data pump server 16 over Internet 20 in a known manner. In one embodiment, computers 12 and 14 request a Uniform Resource Locator (“URL”) for a Web page residing on server 16. Computers 12 and 14 also use a proxy server or negotiate a firewall such as firewalls 30, 22 if necessary, to access Internet 20. In one embodiment, computers 12, 14 establish a Transmission Control Protocol/Internet Protocol (“TCP/IP”) connection to server 16. Once such a connection is established, the firewalls and proxy servers no longer monitor data passing through them.

At box 110, each computer 12 and 14 identifies itself to data pump server 16. Data pump server 16 then adds the identity of computers 12, 14 to its connection table. Any other computer that has established a connection with server 16 is also listed on the connection table of server 16. In one embodiment, the connection of viewer computer 12 is authenticated to insure that only authorized users can connect to server 16 and remotely control any agent computers connected to server 16. The authentication can be accomplished via certificates, a user name/password process, or any other method. In other embodiments, agent computer 12 and any other agent computers may also require authentication before being listed on the connection table.

At box 120, viewer computer 12 views the connection table of data pump server 16, and selects the connection of agent computer 14 or any other agent computer that is connected to data pump server 16 and that viewer computer 12 desires to control.

At box 130, data pump server 16 links the two connections (i.e., the connections of viewer computer 12 and agent computer 14) and establishes a channel that routes data from one connection to another, and vice versa. In effect, data pump server 16 behaves as a router between the viewer computer and the agent computer. The data is continuously and bi-directionally exchanged between the viewer and agent computer. At this point, viewer computer 12 can remotely control agent computer 14 using the viewer and agent software executed in computers 12 and 14, respectively.

In one embodiment, Secure Sockets Layer (“SSL”) encryption is used by all computers at box 100 when establishing a connection to data pump server 16. The use of SSL enables data to reach data pump 16 through a firewall. Then, at step 130 when data pump 16 establishes a channel between the viewer and agent computer, that channel is a non-SSL channel, which avoids the SSL encryption/decryption which slows down data transmission speed. However, if added security is required, SSL can be used in the channel between the viewer and agent computer. In another embodiment, Transport Layer Security (“TLC”, defined in Requests for Comments (“RFC”) 2246) is used by all or some of the computers at box 100 when establishing a connection to data pump server 16.

Embodiments of the present invention provide multiple advantages over the prior art. Because communications to data pump server 16 are initiated at an agent computer and a viewer computer, a potential firewall at either the agent or viewer computer will not block the communications.

Prior art management products typically require agent software to be installed on the controlled/agent computers before remote control could be performed. However, in one embodiment of the present invention, since both the viewer computer and agent computer initiate the communications, the installation of the agent computer software or viewer computer software can be delayed until remote control is actually desired. In one embodiment, the agent computer software is relatively small (approximately 300 Kb) so downloading it even over a 56 Kb modem only takes around one minute. Once the remote control session is complete, it can be removed. Using this technology results in at least two advantages: since the agent software is only present when in use, no resources (e.g., memory, processor, or disk) are required except when the remote control function is active; and issues of upgrading the agent computer and viewer computer software are greatly simplified—the upgrades only need to be placed on the download server (i.e., data pump server 16).

Data pump server 16 may work in coordination with regular Web, messaging, and database services. It is a component whose primary purpose is to identify and route continuous bidirectional data. Much of management consists of presentation and simple data entry. This is more simply performed with Web and messaging services, and using these services makes it simpler to adapt the presentation and appearance (e.g., look and feel) of the management applications. In one embodiment, data pump server 16 logs connection information (e.g., connection time, bytes transmitted, identification information, etc.). This information may be directed to a database server to provide a centralized source of connection information. In addition, data pump server 16 adds the ability to perform operations that cannot normally be performed by regular Web services such as remote control and remote diagnostics.

Performance of data pump server 16 may be limited only by bandwidth availability. The only disk space requirements of the data pump server 16 in one embodiment are those needed for the logs, the program itself, and some configuration files. Parameters such as the maximum number of connections can be changed by editing the configuration files or by command line options. Every active connection reduces the amount of available bandwidth for other connections. In one embodiment, the remote control protocol compresses the data and sends only changes—once the initial screen has been transmitted, only screen updates are sent. This considerably reduces the bandwidth requirements. The actual number of connections that can be served by a single data pump server will depend on the type and activity of the connections. A large number of modem connections could be served, because no matter how much screen activity is occurring a modem is limited by its baud rate. A lesser number of high-speed and active connections can be served.

As described, embodiments of the present invention allow remote control operations to be executed even when the viewer and/or agent computers are behind a firewall or proxy server.

In addition, besides a remote control function, the present invention can be used for any other applications that require continuous bi-directional communication through firewalls. One such application is remote debugging in which the data pump allows an agent computer to control a debugging program that is executing on a viewer computer, which can allow a remote user to set break-points, inspect data value's, etc.

Several embodiments of the present invention are specifically illustrated and/or described herein. However, it will be appreciated that modifications and variations of the embodiments present invention are covered by the above teachings and within the purview of the appended claims without departing from the spirit and intended scope of the invention.

What is claimed is:

1. A method of remotely controlling a computer comprising:
receiving a first connection request from a viewer computer;
receiving a second connection request from an agent computer;
adding a first identity of the viewer computer connection to a connection table;
adding a second identity of the agent computer connection to the connection table;
receiving a control request from the viewer computer for the second identity of the agent computer; and
establishing a communication channel between the viewer computer and the agent computer.

2. The method of claim 1, wherein the first connection request and second connection request are received via an Internet.

3. The method of claim 1, further comprising:
continuously and bi-directionally routing data over the communication channel.

4. The method of claim 2, wherein the first connection request and second connection request implement Secure Sockets Layer encryption.

5. The method of claim 1, wherein the first connection request is received through a first firewall.

6. The method of claim 1, wherein the second connection request is received through a second firewall.

7. The method of claim 1, further comprising:
authorizing the first connection request before adding the first identity of the viewer computer connection to the connection table.

8. The method of claim 1, further comprising:
logging connection information about the communication channel.

9. The method of claim 1, further comprising:
downloading agent software to the agent computer.

10. The method of claim 9, further comprising:
removing the agent software from the agent computer after a remote controlling of the agent computer is complete.

11. A computer readable medium having instructions stored thereon that, when executed by a processor, cause the processor to:
receive a first connection request from a viewer computer;
receive a second connection request from an agent computer;
add a first identity of the viewer computer connection to a connection table;
add a second identity of the agent computer connection to the connection table;
receive a communication channel request from the viewer computer for the second identity of the agent computer; and
establish a communication channel between the viewer computer and the agent computer.

12. The computer readable medium of claim 11, wherein the first connection request and second connection request are received via an Internet.

13. The computer readable medium of claim 11, said instructions further causing said processor to:
continuously and bi-directionally route data over the communication channel.

14. The computer readable medium of claim 12, wherein the first connection request and second connection request implement Secure Sockets Layer encryption.

15. The computer readable medium of claim 11, wherein the first connection request is received through a first firewall.

16. The computer readable medium of claim 11, wherein the second connection request is received through a second firewall.

17. The computer readable medium of claim 11, said instructions further causing said processor to:
authorize the first connection request before adding the first identity of the viewer computer connection to the connection table.

18. The computer readable medium of claim 11, said instructions further causing said processor to:
log connection information about the communication channel.

19. The computer readable medium of claim 11, said instructions further causing said processor to:
download agent software to the agent computer.

20. The computer readable medium of claim 13, said instructions further causing said processor to allow the viewer computer to remotely control the agent computer.

21. The computer readable medium of claim 13, said instructions further causing said processor to allow the viewer computer to remotely debug the agent computer.

22. A system for allowing remote control of a controlled computer, said system comprising:
a processor;
a memory coupled to said processor,
said memory having instructions stored thereon that cause said processor to:
add a first identity of a controller computer connection to a connection table after receiving a first connection request from the viewer computer;
add a second identity of the controlled computer connection to the connection table after receiving a second connection request from the controlled computer; and
establish a communication channel between the control computer and the controlled computer.

23. The system of claim 22, wherein the first connection request and second connection request are received via an Internet.

24. The system of claim 22, said instructions further causing said processor to:
continuously and bi-directionally route data over the communication channel.

25. The system of claim 23, wherein the first connection request and second connection request implement Secure Sockets Layer encryption.

26. The system of claim 22, wherein the first connection request is received through a first firewall.

27. The system of claim 22, wherein the second connection request is received through a second firewall.

28. The system of claim 22, said instructions further causing said processor to:
authorize the first connection request before adding the first identity of the viewer computer connection to the connection table.

29. The system of claim 22, said instructions further causing said processor to:
log connection information of the communication channel.

30. The system of claim 22, said instructions further causing said processor to:
download controlled computer software to the controlled computer.

31. The system of claim 30, said instructions further causing said processor to:
remove the controlled computer software from the controlled computer.

32. The system of claim 22, said instructions further causing said processor to:
download control computer software to the control computer.
